(19) United States
(12) Patent Application Publication
(10) Pub. No.: US 2026/0071932 A1
(43) Pub. Date: Mar. 12, 2026

(54) LIQUID DETECTION LAMINATES FOR CABLES AND METHODS FOR THE SAME

(71) Applicant: Neenah, Inc., Alpharetta, GA (US)

(72) Inventor: Simon Terry, Alpharetta, GA (US)

(21) Appl. No.: 19/326,160

(22) Filed: Sep. 11, 2025

Related U.S. Application Data
(60) Provisional application No. 63/693,849, filed on Sep. 12, 2024.

(51) Int. Cl. G01M 3/16; G01M 3/18

(52) U.S. Cl. CPC G01M 3/165; G01M 3/181

(57) ABSTRACT

A liquid detection laminate, an electrical cable including the liquid detection laminate, and methods for the same are described herein. The liquid detection laminate may include an electrically insulating substrate, a hydrophilic layer disposed adjacent the electrically insulating substrate and forming a laminate with the electrically insulating substrate, and a conductive wire interposed between the electrically insulating substrate and the hydrophilic layer. The electrical cable may include a cable core, an outer sheath disposed radially outward of the cable core, and the liquid detection laminate interposed between the cable core and the outer sheath.

### CROSS-REFERENCE TO RELATED APPLICATIONS

This application claims the benefit of U.S. Provisional Application No. 63/693,849 filed Sep. 12, 2024, the complete disclosure of which is incorporated herein by reference for all purposes.

### TECHNICAL FIELD

The following description generally relates to laminates or wraps used in the manufacture of cables, such as optical and power cables, and more particularly, liquid detection laminates for detecting or monitoring the presence and/or location of moisture, water, fluids, or liquids (e.g., conductive liquids).

### BACKGROUND

Water or moisture penetration into cables, such as power or optical cables, may often result in their failure. For example, the presence of water in the cable may cause short circuiting and degradation of one or more components of the cable. To mitigate the penetration of moisture and water, conventional cables often incorporate reinforcing sheaths and/or shields at or proximal to the outer surface thereof. While the sheaths and shields have been generally successful in mitigating the penetration of moisture and preventing failure, improved systems and liquid detection laminates thereof for detecting the ingress of moisture and water would provide further improvements to the cables.

### BRIEF SUMMARY

This following is intended merely to introduce a simplified summary of some aspects of one or more implementations of the subject matter discussed herein. Further areas of applicability of the subject matter will become apparent from the detailed description provided hereinafter. This summary is not an extensive overview, nor is it intended to identify key or critical elements of the present teachings, nor to delineate the scope of the subject matter. Rather, its purpose is merely to present one or more concepts in simplified form as a prelude to the detailed description below.

The foregoing and/or other aspects and utilities described herein may be achieved by providing a liquid detection laminate including an electrically insulating substrate or layer, a hydrophilic layer disposed adjacent the electrically insulating substrate and forming a laminate therewith, and a conductive wire interposed between the electrically insulating substrate and the hydrophilic layer.

In one aspect, the electrically insulating substrate may include a polyester.

In one aspect, the polyester may be or include or more of polyethylene terephthalate, polyethylene naphthalate, polybutylene terephthalate, poly(propylene terephthalate), or a combination thereof.

In one aspect, the polyester may be polyethylene terephthalate (PET).

In one aspect, the hydrophilic layer may be a porous, nonwoven sheet configured to absorb liquids.

In one aspect, the nonwoven sheet may include hydrophilic polyester fibers.

In one aspect, the nonwoven sheet may include polyester fibers and a hydrophilic coating disposed on the polyester fibers

In one aspect, the electrically insulating substrate may be a heat sealable polyethylene terephthalate film.

In one aspect, the electrically insulating substrate may be an adhesive coated polyethylene terephthalate film.

In one aspect, the liquid detection laminate may be substantially free of an adhesive.

In one aspect, the liquid detection laminate may include or only include the electrically insulating substrate, the hydrophilic layer, and the conductive wire.

In one aspect, the liquid detection laminate may further include a second conductive wire interposed between the electrically insulating substrate and the hydrophilic layer, wherein the second conductive wire may be disposed proximal to the conductive wire.

In one aspect, the liquid detection laminate may include or may only include the electrically insulating substrate, the hydrophilic layer, the conductive wire, and the second conductive wire.

The foregoing and/or other aspects and utilities described herein may be achieved by providing an electrical cable including a cable core or conductor core, an outer sheath disposed radially outward of the cable core, and the liquid detection laminate described herein interposed between the cable core and the outer sheath. The hydrophilic layer may be disposed proximal, adjacent, or directly adjacent the outer sheath.

In one aspect, the liquid detection laminate may be helically wrapped in the electrical cable.

In one aspect, the liquid detection laminate may be disposed longitudinally along a length of the electrical cable.

The foregoing and/or other aspects and utilities described herein may be achieved by providing a method for fabricating a cable, such as an electrical or power cable, and optical cable, or the like. The method may include interposing the liquid detection laminate described herein between a cable core and an outer sheath of the electrical cable.

The foregoing and/or other aspects and utilities described herein may be achieved by providing a method for detecting the ingress of water into a cable, such as an electrical or power cable, and optical cable, or the like. The method may include interposing the liquid detection laminate described herein between a cable core and a metal sheath or conductive component of the cable.

In one aspect, the method may further include electrically coupling the conductive wire of the liquid detection laminate with the conductive component of the cable via a conductive wire or circuit.

In one aspect, the method may further include measuring a change in one or more electrical properties via the circuit. In one aspect, measuring a change in one or more electrical properties via the circuit may include measuring a change in capacity, resistivity, impedance, or a combination thereof.

The foregoing and/or other aspects and utilities described herein may be achieved by providing a method for detecting the ingress of water into a cable, such as an electrical or power cable, and optical cable, or the like. The method may include disposing the liquid detection laminate described herein radially outward of a cable core of the electrical cable. The method may also include electrically coupling the conductive wire and the second conductive wire with one another via a circuit.

In one aspect, the method may include measuring a change in one or more electrical properties via the circuit. Measuring a change in one or more electrical properties via the circuit may include measuring a change in capacity, resistivity, impedance, or a combination thereof.

Further areas of applicability of the subject matter will become apparent from the detailed description provided hereinafter. It should be understood that the detailed description and specific examples, while indicating some typical aspects of the subject matter, are intended for purposes of illustration only and are not intended to limit the scope thereof.

The recitation herein of desirable objects which may be met by various embodiments of the present description is not meant to imply or suggest that any or all of these objects may be present as essential features, either individually or collectively, in the most general embodiment of the present description or any of its more specific embodiments.

### BRIEF DESCRIPTION OF THE DRAWINGS

The accompanying drawings, which are incorporated in and constitute a part of this specification, illustrate several embodiments of the subject matter and, together with the description, serve to explain the principles thereof.

FIG. 1 illustrates a schematic view of an exemplary power cable, according to one or more implementations discussed herein.

FIG. 2 illustrates a schematic cross-sectional view of an exemplary liquid detection laminate, according to one or more implementations discussed herein.

FIG. 3 illustrates a schematic cross-sectional view of an exemplary liquid detection laminate, according to one or more implementations discussed herein.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

As used throughout, ranges are used as shorthand for describing each and every value that is within the range. It should be appreciated and understood that the description in a range format is merely for convenience and brevity and should not be construed as an inflexible limitation on the scope of any embodiments or implementations discussed herein. Accordingly, the range should be construed to have specifically included all the possible subranges as well as individual numerical values within that range. As such, any value within the range may be selected as the terminus of the range. For example, description of a range such as from 1 to 5 should be considered to have specifically included subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerical values and ranges discussed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is discussed herein, any numerical value falling within the range is also specifically included.

As used herein, “free” or “substantially free” of a material may refer to a composition, component, or phase where the material is present in an amount of less than 10.0 wt %, less than 5.0 wt %, less than 3.0 wt %, less than 1.0 wt %, less than 0.1 wt %, less than 0.05 wt %, less than 0.01 wt %, less than 0.005 wt %, or less than 0.0001 wt % based on a total weight of the composition, component, or phase.

All references cited herein are hereby incorporated by reference in their entireties. In the event of a conflict in a definition with a cited reference, the present teachings control.

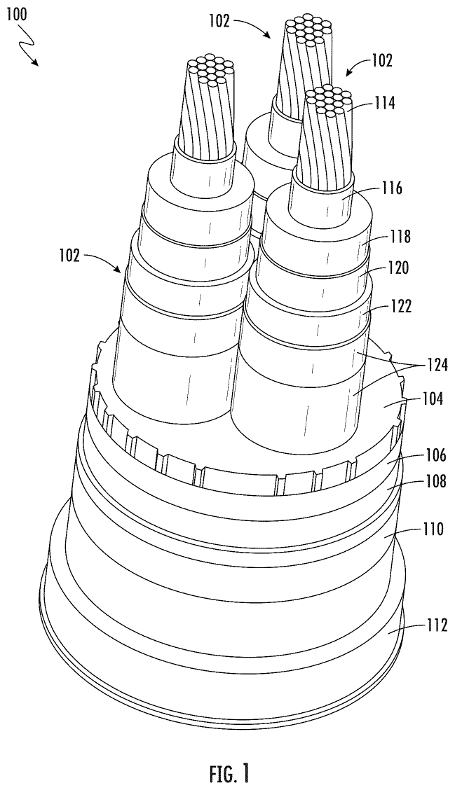

FIG. 1 illustrates a schematic view of an exemplary power or electrical cable 100, according to one or more implementations. The power cable 100 may include one or more conductor assemblies (three are shown 102), a cable jacket 104, one or more layers of a binder tape 106, one or more inner sheaths or coverings 108, one or more layers of armor 110 (e.g., metal armor), an outer sheath or covering 112, or any combination thereof. For example, as illustrated in FIG. 1, the power cable 100 may include three conductor assemblies 102 seated or otherwise disposed in a cable jacket 104, a layer of a binder tape 106 disposed about the cable jacket 104, an inner sheath 108 disposed about the binder tape 106, a layer of armor or metal sheath 110 disposed about the inner sheath 108, and an outer sheath 112 disposed about the metal sheath 110. It should be appreciated that the power cable 100 may exclude any one or more of the foregoing components. For example, the power cable 100 may exclude the binder tape 106, the inner sheath 108, or any combination thereof. The cable jacket 104 may be or include a filler material, such as a polymeric filler material, capable of or configured to fill a void in the power cable 100. The binder tape 106 may be capable of or configured to at least partially reinforce the power cable 100 and/or a component thereof. The inner sheath 108 may be capable of or configured to provide a barrier to separate two or more components of the power cable 100. The inner sheath 108 may also be capable of or configured to provide a base, bed, or substrate for the metal sheath 110. The metal sheath 110 may be fabricated from a conductive material, such as metal. For example, the metal sheath 110 may be a metal sheath. The metal sheath 110 may be capable of or configured to reinforce the power cable 100. The outer sheath 112 may be capable of or configured to encase or provide a barrier for the power cable 100 to protect the components thereof from the environment (e.g., subsea environment).

It should be appreciated that each of the conductor assemblies 102 discussed herein may include similar components and parts. Consequently, discussions regarding a single conductor assembly 102 are equally applicable to the remaining conductor assemblies 102. The conductor assembly 102 may include a conductor core 114, one or more conductor shields 116, one or more insulation layers 118, one or more insulation shields or screens 120, one or more metallic shields or screens 122, one or more barrier layers 124, or any combination thereof. For example, as illustrated in FIG. 1, the conductor assembly 102 may include a conductor core 114, a conductor shield 116 disposed about the conductor core 114, an insulation layer 118 disposed about the conductor shield 116, an insulation shield or screen 120 disposed about the insulation layer 118, a metallic shield or screen 122 disposed about the insulation shield 120, and one or more barrier layers (two are shown 124) disposed about the metallic shield 122. It should be appreciated that the conductor assembly 102 may exclude any one or more of the foregoing components. For example, the conductor assembly 102 may exclude the one or more barrier layers, the insulation shield 120, or any combination thereof.

In at least one implementation, a liquid detection laminate, tape, or wrap, as described herein, may be utilized in the fabrication or preparation of the power cable 100 and/or one or more of the conductor assemblies 102 thereof. For example, the liquid detection laminate described herein may be used for or in the preparation of any one or more components of the power cable 100 and/or one or more of the conductor assemblies 102 thereof. In another example, the liquid detection laminate described herein may be used in addition to or in conjunction with any one or more components of the power cable 100 and/or one or more of the conductor assemblies 102 thereof. For example, the liquid detection laminate described herein may be disposed proximal or adjacent to any one or more components of the power cable 100 and/or one or more of the conductor assemblies 102 thereof. For example, the liquid detection laminate may be disposed proximal or adjacent to the conductor core 114, the conductor shield 116, the insulation layer 118, the insulation shield 120, the metal screen 122, the barrier layers 124, the cable jacket 104, the binding tape 106, the inner sheath 108, the metal sheath 110, the outer sheath 112, or any combination thereof.

In at least one implementation, as further described herein, the liquid detection laminate may be operated in conjunction with any one or more conductive components of the power cable 100 and/or one or more of the conductor assemblies 102 thereof. For example, the liquid detection laminate described herein may be disposed adjacent one or more conductive components of the power cable 100 and/or one or more of the conductor assemblies 102 thereof. In an exemplary implementation, the liquid detection laminate described herein may be disposed proximal or adjacent the cable core 114 of the conductor assembly 102, the metal screen or shield 122 of the conductor assembly 102, the metal sheath 110 of the power cable 100, or any combination thereof. The liquid detection laminate described herein may be disposed radially inward and/or radially outward of the cable core 114, the metal shield 122, the metal sheath 110, or any combination thereof.

In another exemplary implementation, the liquid detection laminate may not be operated in conjunction with any one or more conductive components of the power cable 100 and/or one or more of the conductor assemblies 102 thereof. For example, the liquid detection laminate may be operated or utilized without being disposed proximal or adjacent a conductive component of the power cable 100 and/or the conductor assemblies 102 thereof. The liquid detection laminate may be disposed radially outward of the conductor shield 116, the insulating layer 118, the insulating shield 120, the barrier layers 124, the cable jacket 104, the binding tape 106, the inner sheath 108, the metal sheath 110, or any combination thereof.

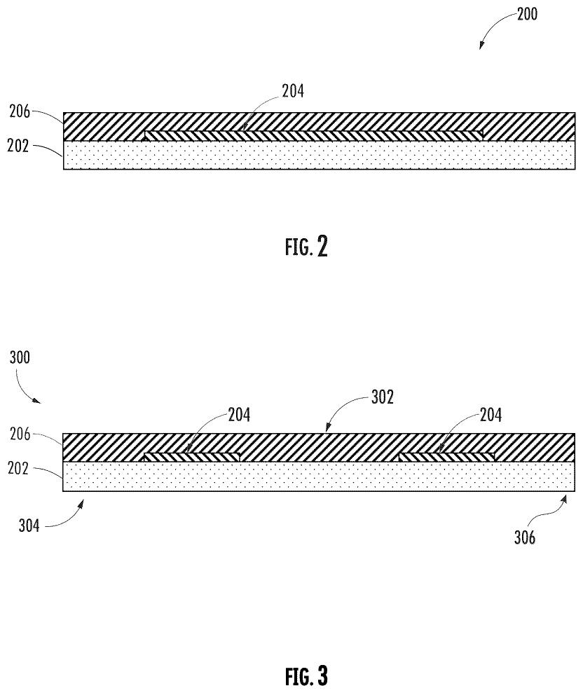

FIG. 2 illustrates a schematic cross-sectional view of an exemplary liquid detection laminate 200, according to one or more implementations discussed herein. The liquid detection laminate 200 may include an insulating layer 202 (e.g., electrically insulating layer), a conductive layer or wire 204, a hydrophilic layer 206, or any combination thereof. For example, as illustrated in FIG. 2, the liquid detection laminate 200 may include the insulating layer 202, the hydrophilic layer 206 disposed proximal or adjacent the insulating layer 202, and the conductive layer 204 interposed between the insulating layer 202 and the hydrophilic layer 206. The conductive layer 204 may be laminated or otherwise sealed between the insulating layer 202 and the hydrophilic layer 206.

The insulating layer 202 may be capable of or configured to provide or form a substrate (e.g., electrically insulating substrate) for the liquid detection laminate 200. The insulating layer 202 may also be capable of or configured to provide a barrier between one or more components of the power cable 100 or the conductor assembly 102 and the conductive layer 204. For example, the insulating layer 202 may be capable of or configured to provide a moisture or hydrophobic barrier between one or more components of the power cable 100 or the conductor assembly 102 and the conductive layer 204. In another example, the insulating layer 202 may also be capable of or configured to provide an electrical or conductivity barrier between one or more components of the power cable 100 or the conductor assembly 102 and the conductive layer 204.

In at least one implementation, the insulating layer 202 may be fabricated from or include one or more electrically insulating materials. For example, the electrically insulating material of the insulating layer 202 may be or include, but are not limited to, one or more of a fluorocarbon resin or polymer, such as a polytetrafluoroethylene (PTFE), a tetrafluoroethylene-hexafluoropropylene copolymer, a tetrafluoroethylene-ethylene copolymer, or the like, a polyolefin resin or polymer, such as a polyethylene, a polypropylene, an ethylene vinyl acetate, or the like, a polyvinyl chloride, a polymethylpentene, a polyethylene terephthalate (PET), a high-density polyethylene, a polycarbonate, a polyethylene naphthalate, a polyester, a polyamide, any other electrically insulating material, cellulose, polyimide, polyimide-amide, polyphenylene sulfide, polybenzimidazole, a polybutylene terephthalate, a poly(propylene terephthalate), a rubber, copolymers thereof, or the like, or any combination thereof. In an exemplary implementation, the insulating layer 202 may be or include a polyethylene terephthalate, such as a heat sealable polyethylene terephthalate polymer or resin.

The insulating layer 202 may be or include a nonwoven sheet prepared from a plurality of fibers. For example, the insulating layer 202 may be or include a nonwoven sheet prepared from a plurality of fibers of any one or more of the electrically insulating materials described herein. The insulating layer 202 may also be or include a woven sheet prepared from a plurality of fibers (e.g., fibers of the electrically insulating materials). In another implementation, the insulating layer 202 may be or include a solid continuous film prepared from any one or more of the electrically insulating materials described herein.

The insulating layer 202 may have any size and/or shape capable of or configured to provide a substrate for the conductive layer 204 and/or the hydrophilic layer 206. For example, the insulating layer 202 may be relatively wider than the conductive layer or layers 204. In one implementation, the insulating layer 202 may have a width of from about 0.9 cm to about 1.27 cm, about 1.0 cm to about 1.2 cm, or about 1.1 cm.

The conductive layer 204 may be or include, but is not limited to, one or more electrically conductive materials capable of or configured to provide electrical conductivity therethrough. For example, the conductive layer 204 may be or include a durable and flexible metal wire, film, or sheet, prepared from copper, aluminum, stainless steel, or the like, or any combination thereof. In another example, the conductive layer 204 may be or include a filament, film, or sheet of a conductive polymer or resin. It should be appreciated that the particular material of the conductive layer 204 is not limited so long as the material is capable of or configured to provide electrical conductivity therethrough. The conductive layer 204 may have any size and/or shape capable of or configured to be disposed between the insulating layer 202 and the hydrophilic layer 206. In one implementation, the conductive layer 204 may have a width of about 0.25 inches (about 0.635 cm) or less and/or a thickness of about 0.003 inches (about 0.008 cm) or less.

The hydrophilic layer 206 may be capable of or configured to provide a barrier between one or more components of the power cable 100 or the conductor assembly 102 and the conductive layer 204. For example, the hydrophilic layer 206 may provide a physical or structural barrier (e.g., spacer) between one or more components of the power cable 100 or the conductor assembly 102 and the conductive layer 204. The hydrophilic layer 206 may also be capable of or configured to provide permeability to or a permeable layer for one or more liquids. For example, the hydrophilic layer 206 may be capable of or configured to provide permeability to one or more conductive liquids (e.g., salt water). The hydrophilic layer 206 may be capable of or configured to provide an electrically insulating layer between one or more components of the power cable 100 or the conductor assembly 102 and the conductive layer 204 when dry or substantially free of a liquid, such as a conducting liquid. The hydrophilic layer 206 may also be capable of or configured to provide an electrically conducting layer between one or more components of the power cable 100 or the conductor assembly 102 and the conductive layer 204 when wet or wetted with a liquid, such as a conducting liquid. The hydrophilic layer 206 may be fabricated from or include one or more of the electrically insulating materials described herein.

The hydrophilic layer 206 a nonwoven sheet prepared from a plurality of fibers. For example, the hydrophilic layer 206 may be or include a nonwoven sheet prepared from a plurality of fibers of any one or more of the electrically insulating materials described herein. The hydrophilic layer 206 may include pores capable of or configured to provide permeability to the conductive liquids. For example, the hydrophilic layer 206 may be or include a porous nonwoven sheet. In another example, the hydrophilic layer 206 may be or include a porous continuous film prepared from any of the electrically insulating materials described herein. In an exemplary implementation, the hydrophilic layer 206 may be or include a nonwoven sheet prepared from a plurality of hydrophilic polyester fibers, such as a chemically treated polyester fibers. The plurality of hydrophilic polyester fibers may be or include polyester fibers including a hydrophilic coating disposed on surfaces thereof. The hydrophilic layer 206 may not be water soluble.

The plurality of hydrophilic polyester fibers may be capable of or configured to absorb, attract, and/or concentrate the conductive liquids proximal or adjacent the conductive layer 204 of the liquid detection laminate 200. In at least one implementation, a portion of the hydrophilic layer 206 directly adjacent or proximal to the conductive layer 204 may be relatively more absorbent or hydrophilic as compared to a portion of the hydrophilic layer 206 directly adjacent or proximal to the insulating layer 202. For example, the portion of the hydrophilic layer 206 directly adjacent or proximal to the conductive layer 204 may be or include chemically-treated polyester fibers capable of or configured to absorb or concentrate the conductive liquid, and the portion of the hydrophilic layer 206 directly adjacent or proximal to the insulating layer 202 may be or include untreated and/or hydrophobic polyester fibers capable of or configured to at least partially direct the conductive liquid toward the portion of the hydrophilic layer 206 adjacent or proximal to the conductive layer 204.

The hydrophilic layer 206 may have any size and/or shape capable of or configured to provide a barrier for the conductive layer 204. For example, the hydrophilic layer 206 may be relatively wider than the conductive layer or layers 204. In one implementation, the hydrophilic layer 206 may have a size and/or shape substantially similar to the size and/or shape of the insulating layer 202. For example, the hydrophilic layer 206 may have a width of from about 0.9 cm to about 1.27 cm, about 1.0 cm to about 1.2 cm, or about 1.1 cm.

FIG. 3 illustrates a schematic cross-sectional view of an exemplary liquid detection laminate 300, according to one or more implementations discussed herein. It should be appreciated that the liquid detection laminate 300 and/or one or more components thereof may be similar in some respects to the liquid detection laminate 200 described above, and therefore, may be best understood with reference to the description of FIG. 2, where like numerals designate like components and will not be described again in detail.

As illustrated in FIG. 3, the liquid detection laminate 300 may include an insulating layer 202, a hydrophilic layer 206 disposed proximal or adjacent the insulating layer 202, and a plurality of conductive layers (two are shown 204) interposed between the insulating layer 202 and the hydrophilic layer 206. While FIG. 3 illustrates the liquid detection laminate 300 as including two conductive layers 204, it should be appreciated that the liquid detection laminate 300 may include two, three, four, or more conductive layers 204. The conductive layers 204 of the liquid detection laminate 300 may be disposed between the insulating layer 202 and the hydrophilic layer 206 such that the conductive layers 204 are not in direct electrical contact with one another. For example, the conductive layers 204 may be disposed or spaced apart from one another in a parallel orientation along a length of the liquid detection laminate 300.

Referring to FIG. 3, a portion of the hydrophilic layer 206 directly adjacent or proximal one or more of the conductive layers 204 may be relatively more absorbent or hydrophilic as compared to another portion of the hydrophilic layer 206 directly adjacent or proximal to the lateral end portions of the liquid detection laminate 300. For example, a portion or region 302 of the hydrophilic layer 206 disposed between the conductive layers 204 may be relatively more absorbent or hydrophilic as compared to lateral end portions 304, 306 of the hydrophilic layer 206 directly adjacent or proximal lateral end portions of the liquid detection laminate 300.

The liquid detection laminate 200, 300 described herein may be in the form of a sheet, a strip, a roll, a film, or the like. The liquid detection laminate 200, 300 may be flexible. The liquid detection laminate 200, 300 may be prepared as a tape or sheet capable of or configured to be disposed along at least a portion of a length of the power cable 100 and/or the conductor assemblies 102 thereof. For example, the liquid detection laminate 200, 300 may be prepared as a layer of the power cable 100 and/or the conductor assemblies 102 thereof. In another example, the liquid detection laminate 200, 300 may be prepared as a sheet capable of or configured to form a respective layer of the power cable 100 and/or the conductor assembly 102 thereof by forming a longitudinal tube around one or more components of the power cable 100 and/or the conductor assembly 102 thereof. The sheet of the liquid detection laminate 200, 300 may form a longitudinal tube having an overlapping seam. The overlapping seam of the longitudinal tube may be sealed (e.g., hermetically sealed, heat sealed, etc.) by any suitable means to form the respective layer of the power cable 100 and/or the conductor assembly 102 thereof.

In at least one implementation, the liquid detection laminate 200, 300 may be prepared as a tape or strip capable of or configured to be disposed along at least a portion of a length of the power cable 100 and/or the conductor assembly 102 thereof. For example, the liquid detection laminate 200, 300 may be prepared as a tape capable of or configured to be helically wrapped around one or more components of the power cable 100 and/or the conductor assembly 102 thereof. For example, the liquid detection laminate 200, 300 may be helically wrapped around the inner sheath 108 and disposed radially inward of the metal sheath 110. The liquid detection laminate 200, 300 in the form of a tape or strip may be disposed helically with an overlap, thereby providing or forming an overlapping seam. The liquid detection laminate 200, 300 in the form of a tape or strip may also be disposed longitudinally along one or more components of the power cable 100 and/or the conductor assembly 102 thereof, such that the liquid detection laminate 200, 300 is parallel or substantially parallel with the power cable 100 or the conductor assembly 102. It should be appreciated that the power cable 100 or the conductor assembly 102 may include a plurality of any one or more of the liquid detection laminates 200, 300. For example, two or more of the liquid detection laminates 200, 300 may be disposed proximal or adjacent to one another.

The liquid detection laminate 200, 300 may be disposed radially inward or radially outward of one or more components of the power cable 100 and/or the conductor assembly 102 such that the respective insulating layer 202 thereof is radially inward of the respective hydrophilic layer thereof. For example, the liquid detection laminate 200, 300 may be disposed radially inward or radially outward of one or more components of the power cable 100 and/or the conductor assembly 102 such that the respective hydrophilic layer 206 is relatively closer to the outer sheath 112 of the power cable 100 than the respective insulating layer 202. It should be appreciated that the liquid detection laminate 200, 300 may be utilized in any kind of cable or cable assembly, and is not limited to power cables and conductor assemblies. For example, the liquid detection laminate 200, 300 may be utilized in communication cables, optical cables, or the like, or any combination thereof.

As discussed above, the nonwoven sheet of the insulating layer 202 and/or the hydrophilic layer 206 may be prepared from a plurality of fibers. The plurality of fibers may be prepared from one or more electrically insulating materials, such as one or more electrically insulating polymers or resins. For example, the nonwoven sheet and/or the plurality of fibers thereof may be prepared from a single polymer, a single copolymer, or a single synthetic resin. In another example, the nonwoven sheet and/or the plurality of fibers thereof may be prepared from a plurality of polymers, resins, copolymers, or any combination thereof. In at least one example, the nonwoven sheet may be prepared from a first plurality of fibers and a second plurality of fibers, wherein the second plurality of fibers is different than the first plurality of fibers. It should be appreciated that the nonwoven sheet may be prepared from any number of fibers. For example, the nonwoven sheet may include a first plurality of fibers, a second plurality of fibers, a third plurality of fibers, a fourth plurality of fibers, or more, where each of the respective pluralities of fibers are different from the remaining plurality of fibers. As used herein, the differences between any of the plurality of fibers may be or include, but is not limited to, a molecular weight, a melting point, a glass transition temperature, an average fiber length, an average fiber diameter, a composition, one or more physical properties (e.g., mechanical strength, tensile strength, tenacity, etc.), or the like, or any combination thereof.

In at least one implementation, the nonwoven sheet includes a first plurality of fibers prepared from a synthetic resin. For example, the first plurality of fibers may be or include polyester fibers or filaments. The first plurality of fibers may be or include drawn fibers. In an exemplary implementation, the first plurality of fibers may be or include polyethylene terephthalate (PET) fibers.

In at least one implementation, the nonwoven sheet includes the first plurality of fibers and a second plurality of fibers. The second plurality of fibers may be capable of or configured to increase a strength of the nonwoven sheet by fusing, welding, or otherwise coupling fibers (e.g., first and/or second plurality of fibers) of the nonwoven sheets with one another. For example, the second plurality of fibers may be capable of or configured to couple fibers (e.g., the first and/or second plurality of fibers) of the nonwoven sheet with one another at intersecting or intersection points formed with respective fibers of the second plurality of fibers. The second plurality of fibers may be or include, but are not limited to, one or more thermoplastic compositions or fibers. Illustrative thermoplastic compositions may be or include, but are not limited to, polyester, polyolefin, nylon, amides, polyphenylene sulfide, or the like, or any combination thereof. In an exemplary implementation the second plurality of fibers includes polyester fibers or filaments prepared from polyester resins. The polyester fibers or filaments of the second plurality of fibers may be undrawn polyester fibers. In an exemplary implementation, the second plurality of fibers may be or include polyethylene terephthalate (PET) fibers. The polyester fibers or filaments of the second plurality of fibers may have a melting point and/or glass transition temperature relatively lower than the melting point and/or glass transition temperature of the first plurality of fibers. For example, the polyester fibers of the second plurality of fibers may have a melting point and a glass transition temperature relatively lower than the melting point and glass transition temperature of the polyester fibers of the first plurality of fibers. The relatively lower melting point and/or glass transition temperature of the second plurality of fibers may facilitate the fusing, welding, binding, or otherwise coupling of the fibers of the nonwoven sheet via thermal heating (e.g., thermal pressing, calendaring, etc.). The melting point of the second plurality of fibers or the polyester fibers thereof may be from about 120° C. to about 260° C.

The nonwoven sheet may include the first plurality of fibers and the second plurality of fibers in varying weight ratios. For example, the weight ratio of the first plurality of fibers to the second plurality of fibers may be from about 1:5 (about 1 to about 5) to about 5:1. In one example, the weight ratio of the first plurality of fibers to the second plurality of fibers may be from about 1:5, about 2:5, about 3:5, about 4:5, or about 5:5 to about 5:4, about 5:3, about 5:2, or about 5:1. In yet another example, the weight ratio of the first plurality of fibers to the second plurality of fibers may be from about 1:10 to about 10:1.

The nonwoven sheet including the first plurality of fibers and the second plurality of fibers may include the first plurality of fibers in an amount of from about 10 wt % to about 90 wt %, based on the total weight of the nonwoven sheet. For example, the first plurality of fibers may be present in the nonwoven sheet in an amount of from about 10 wt %, about 20 wt %, about 30 wt %, or about 40 wt % to about 50 wt %, about 60 wt %, about 70 wt %, about 80 wt %, or about 90 wt %, based on the total weight of the nonwoven sheet. In another example, the first plurality of fibers may be present in the nonwoven sheet in an amount of from about 10 wt % to about 90 wt %, about 20 wt % to about 80 wt %, about 30 wt % to about 70 wt %, or about 40 wt % to about 60 wt %, based on the total weight of the nonwoven sheet.

The nonwoven sheet including the first plurality of fibers and the second plurality of fibers may include the second plurality of fibers in an amount of from about 10 wt % to about 90 wt %, based on the total weight of the nonwoven sheet. For example, the second plurality of fibers may be present in the nonwoven sheet in an amount of from about 10 wt %, about 20 wt %, about 30 wt %, or about 40 wt % to about 50 wt %, about 60 wt %, about 70 wt %, about 80 wt %, or about 90 wt %, based on the total weight of the nonwoven sheet. In another example, the second plurality of fibers may be present in the nonwoven sheet in an amount of from about 10 wt % to about 90 wt %, about 20 wt % to about 80 wt %, about 30 wt % to about 70 wt %, or about 40 wt % to about 60 wt %, based on the total weight of the nonwoven sheet. The second plurality of fibers may be present in an amount sufficient to provide the nonwoven sheet with a sufficient strength and/or a sufficiently uniform surface. In an exemplary implementation, the second plurality of fibers may be present in an amount of from about 20 wt % to about 80 wt % or about 30 wt % to about 70 wt %, based on the total weight of the nonwoven sheet, to thereby provide the nonwoven sheet with a sufficient strength and/or a sufficiently uniform (e.g., even) surface.

The nonwoven sheet may be prepared by mixing, dispersing, or otherwise contacting the first plurality of fibers and the second plurality of fibers with one another according to any conventional manufacturing process. For example, the first plurality of fibers and the second plurality of fibers may be combined with one another via a dry manufacturing process or a wet manufacturing process. The nonwoven sheet may include a combination or mixture of each of the first and second plurality of fibers. The nonwoven sheet may also include one or more layers of the first plurality of fibers and one or more layers of the second plurality of fibers. In another example, the nonwoven sheet may include one or more layers of the first plurality of fibers, one or more layers of the second plurality of fibers, one or more layers of a mixture of the first and second plurality of fibers, or any combination thereof. One or more reagents or agents may be added during the manufacturing process to facilitate the fabrication or preparation of the nonwoven sheet. The one or more reagents and/or agents may be or include, but are not limited to, one or more dispersants, co-dispersants, defoaming agents, hydrophilic agents, antistatic agents, or the like, or any combination thereof. The nonwoven sheet may be prepared by disposing respective layers of the first plurality of fibers adjacent to respective layers of the second plurality of fibers. The respective layers of the first and second plurality of fibers may be disposed adjacent to one another in a pattern, such as an alternating and/or repeating pattern. The respective layers of the first and second plurality of fibers may also be disposed adjacent to one another in a random order.

The nonwoven sheet may be subjected to one or more heating and/or pressing processes. For example, the nonwoven sheet prepared from the first plurality of fiber and/or the second plurality of fibers may be pressed with one or more rollers. In another example, the nonwoven sheet prepared from the first plurality of fiber and/or the second plurality of fibers may be pressed and heated with one or more rollers. The nonwoven sheet may be heated and/or pressed as a single layer or as a plurality of layers. For example, the nonwoven sheet may include, at least, a first layer of the first plurality of fibers and a second layer of the second plurality of fibers. In another example, the nonwoven sheet may include, at least, a first layer including the first and second plurality of fibers, and a second layer including either the first plurality of fibers or the second plurality of fibers. In yet another example, the nonwoven sheet may include a plurality of layers including the first plurality of fibers and a plurality of layers including the second plurality of fibers. The layers of the nonwoven sheet may be repeating layers, alternating layers, random layers, or a combination thereof.

It should be appreciated that one or more variables of the heating and/or pressing processes may be modified to at least partially adjust one or more characteristics or properties of the nonwoven sheet. For example, the temperature of the respective surface of each of the rollers, the pinching force of the rollers, the transporting velocity of the nonwoven sheet, time of pressing, or the like, may be modified to at least partially adjust one or more characteristics or properties of the nonwoven sheet. The one or more characteristics or properties of the nonwoven sheet that may be modified via the variables of the heating and/or pressing processes may be or include, but are not limited to, the permeability of the nonwoven sheet, the average roughness of the nonwoven sheet (e.g., centerline average roughness) at a first side or face and/or a second side or face. The temperature of the roller, if utilized, may be from about 100° C. to about 300° C., about 130° C. to about 280° C., about 150° C. to about 270° C., about 200° C. to about 260° C., or about 200° C. to about 230° C. The pinching force of the rollers may be from about 10 kg/cm to about 200 kg/cm, about 50 kg/cm to about 150 kg/cm, or about 75 kg/cm to about 100 kg/cm. The transporting velocity may be from about 10 m/min to about 150 m/min, about 25 m/min to about 100 m/min, or about 60 m/min to about 75 m/min.

The nonwoven sheet may have an air permeability of from about 0.5 cc/cm²/sec to about 7 cc/cm²/sec. For example, the nonwoven sheet of the insulating layer 202 and/or the hydrophilic layer 204 may have an air permeability of from about 0.5 cc/cm²/sec, about 1 cc/cm²/sec, about 2 cc/cm²/sec, or about 3 cc/cm²/sec to about 5 cc/cm²/sec, about 6 cc/cm²/sec, or about 7 cc/cm²/sec. In another example, the nonwoven sheet may have an air permeability of from about 0.5 cc/cm²/sec to about 7 cc/cm²/sec, about 1 cc/cm²/sec to about 6 cc/cm²/sec, about 3 cc/cm²/sec to about 5 cc/cm²/sec. In yet another example, the nonwoven sheet may have an air permeability of from about 0.5 cc/cm²/sec to about 1.0 cc/cm²/sec, about 0.6 cc/cm²/sec to about 0.9 cc/cm²/sec, or about 0.7 cc/cm²/sec.

The nonwoven sheet of the insulating layer 202 and/or the hydrophilic layer 204 may have an average pore size of from about 5 μm to about 15 μm. For example, the nonwoven sheet of the insulating layer 202 and/or the hydrophilic layer 204 may have an average pore size of from about 5 μm, about 7 μm, or about 9 μm to about 11 μm, about 13 μm, or about 15 μm. In another example, the nonwoven sheet may have an average pore size of from about 5 μm to about 15 μm, about 7 μm to about 13 μm, or about 9 μm to about 11 μm.

In at least one implementation, the liquid detection laminate 200, 300 may be free or substantially free of an adhesive. For example, the liquid detection laminate 200, 300 may not utilize an adhesive when disposed in or about one or more components of the power cable 100 and/or the conductor assemblies 102 thereof. As such, the liquid detection laminate 200, 300 may not be tacky or self-adhering, and may be capable of or configured to be held in place via tension and/or friction (e.g., helically wrapped). In another implementation, an adhesive may be coated or otherwise disposed on a surface of the insulating layer 202. For example, an adhesive may be coated on a surface or face (e.g., bottom surface) of the insulating layer 202 opposite a surface or face of the insulating layer 202 directly adjacent the hydrophilic layer 204. Any suitable adhesive may be utilized.

In at least one implementation, the liquid detection laminates 200, 300 may provide methods for fabricating the power cable 100 and/or the one or more conductor assemblies 102 thereof. The method may include interposing the liquid detection laminate 200, 300 between the conductor core 114 and the cable jacket 104 of the conductor assembly 102. The method may also include interposing the liquid detection laminate 200, 300 between the cable jacket 104 of the conductor assembly 102 and the outer sheath 112 of the power cable 100. The method may also include disposing the liquid detection laminate 200, 300 such that the respective insulating layer 202 thereof is disposed radially inward of the respective hydrophilic layer 206 thereof.

In at least one implementation, the liquid detection laminates 200, 300 may provide methods for detecting the presence or ingress of a liquid into the power cable 100 and/or the one or more conductor assemblies 102 thereof. The method may include interposing any one or more of the liquid detection laminates 200, 300 described herein between the cable core 114 and the outer sheath 112. The method may also include interposing any one or more of the liquid detection laminates 200, 300 described herein between the cable core 114 of the conductor assembly 102 and the barrier layer 124 of the conductor assembly. The method may also include interposing any one or more of the liquid detection laminates 200, 300 described herein between the cable jacket 104 of the power cable 100 and the outer sheath 112 of the power cable 100. The method may also include disposing any one or more of the liquid detection laminates 200, 300 described herein adjacent, radially inward, or radially outward of a conductive component of the power cable 100 and/or the conductor assembly 102, such that the respective hydrophilic layer 206 of the liquid detection laminate 200, 300 is disposed adjacent or directly adjacent the conductive component. For example, the method may include disposing the liquid detection laminate 200, 300 radially inward of the metal screen 122, the metal sheath 110, or any combination thereof, such that the respective hydrophilic layer 206 of the liquid detection laminate 200, 300 is disposed adjacent or directly adjacent the metal screen 122, the metal sheath 110, or any combination thereof, respectively. It should be appreciated that the liquid detection laminate 200, 300 may be disposed adjacent or proximal any one or more components of the power cable 100 and/or the conductor assembly 102 thereof.

The methods for detecting the presence or ingress of a liquid into the power cable 100 and/or the one or more conductor assemblies 102 thereof may also include operably coupling the respective conductive layer 204 of the liquid detection laminate 200, 300 with a conductive component of the power cable 100 and/or the conductor assembly 102. For example, the method may include electrically coupling the respective conductive layer 204 of the liquid detection laminate 200, 300 with the metal screen 122, the metal sheath 110, or any combination thereof. The respective conductive layer 204 may be coupled with the conductive component (e.g., the metal screen 122, the metal sheath 110, or any combination thereof) via any suitable means. For example, the respective conductive layer 204 may be coupled with the conductive component via a circuit, such as a busbar, a wire, a cable, a conductive sheet, or the like, or any combination thereof.

The method for detecting the presence or ingress of a liquid into the power cable 100 and/or the one or more conductor assemblies 102 thereof may also include measuring a change in one or more electrical properties via the circuit. Illustrative electrical properties may be or include, but are not limited to, capacity, resistivity, impedance, or the like, or a combination thereof. As such, measuring a change in one or more electrical properties via the circuit may include measuring a change in capacity, resistivity, impedance, or a combination thereof.

In at least one implementation, the liquid detection laminate 300 of FIG. 3 may provide methods for detecting the presence or ingress of a liquid into the power cable 100 and/or the one or more conductor assemblies 102 thereof. The method may include interposing the liquid detection laminate 300 including a plurality of conductive layers 204 radially outward of the cable core 114 of the conductor assembly 102 and radially inward of the outer sheath 112 of the power cable 100. The method may also include interposing the liquid detection laminate 300 radially outward of the cable core 114 of the conductor assembly 102 and radially inward of the barrier layers 124 of the conductor assembly 102. The method may also include interposing the liquid detection laminate 300 radially outward of the cable jacket 104 of the power cable 100 and radially inward of the outer sheath 112 of the power cable 100. It should be appreciated that the liquid detection laminate 200, 300 may be disposed adjacent or proximal any one or more components of the power cable 100 and/or the conductor assembly 102 thereof.

In an exemplary operation of the liquid detection laminate 200, with continued reference to FIG. 2, the liquid detection laminate 200 may be disposed radially inward of a conductive component of the power cable 100 and/or the conductor assembly 102 thereof. For example, the liquid detection laminate 200 may be disposed adjacent the metal shield 120, the metal sheath 112, or any combination thereof. The liquid detection laminate 200 may be oriented or disposed such that the hydrophilic layer 206 is adjacent or directly adjacent the conductive component (e.g., the metal shield 120, the metal sheath 112, etc.). The conductive layer 204 may be electrically coupled with the conductive component via a circuit. Upon the ingress of liquid, such as a conducting liquid (e.g., sea water), through a fault in the conductive component (e.g., the metal shield 120, the metal sheath 112, etc.) and/or any other component of the power cable 100 or the conductor assembly 102, the liquid will be attracted to the hydrophilic layer 204. The conducting or conductive liquid disposed in the hydrophilic layer 206 would close the circuit between the conductive component and the conductive layer 204 of the liquid detection laminate 200, thereby resulting in a change to one or more electrical properties of the circuit. The change in the electrical properties may be monitored to indicate a fault in the power cable 100 or a component thereof.

In an exemplary operation of the liquid detection laminate 300, with continued reference to FIG. 3, the liquid detection laminate 300 may be disposed adjacent or proximal any one or more components of the power cable 100 and/or the conductor assembly 102 thereof. For example, the liquid detection laminate 300 may be disposed radially inward of the outer sheath 112, the cable jacket 104, the barrier layers 124, the metal screen 122, the inner sheath 108, or any combination thereof. The liquid detection laminate 300 may be oriented or disposed such that the hydrophilic layer 206 is radially outward of the insulating layer 202. The respective conductive layers 204 of the liquid detection laminate 300 may be electrically coupled with one another via a circuit or conductive wire. Upon the ingress of liquid, such as a conducting liquid (e.g., sea water), through a fault in the power cable 100 or the conductor assembly 102, the liquid will be attracted to the hydrophilic layer 204. The conductive liquid disposed in the hydrophilic layer 206 would close the circuit between the plurality of the conductive layers 204 of the liquid detection laminate 300, thereby resulting in a change to one or more electrical properties of the circuit. The change in the electrical properties may be monitored to indicate a fault in the power cable 100, the conductor assembly 102, or a component thereof.

The following numbered paragraphs are directed to one or more exemplary variations of the subject matter of the application:
1. A liquid detection laminate, comprising: an electrically insulating substrate; a hydrophilic layer disposed adjacent the electrically insulating substrate and forming a laminate therewith; and a conductive wire interposed between the electrically insulating substrate and the hydrophilic layer.
2. The liquid detection laminate of paragraph 1, wherein the electrically insulating substrate comprises a polyester.
3. The liquid detection laminate of paragraph 2, wherein the polyester is selected from the group consisting of polyethylene terephthalate, polyethylene naphthalate, polybutylene terephthalate, poly(propylene terephthalate), and a combination thereof.
4. The liquid detection laminate of paragraph 3, wherein the polyester is polyethylene terephthalate.
5. The liquid detection laminate of any one of paragraphs 1 to 4, wherein the hydrophilic layer is a porous, nonwoven sheet configured to absorb liquids.
6. The liquid detection laminate of paragraph 5, wherein the nonwoven sheet comprises hydrophilic polyester fibers.
7. The liquid detection laminate of paragraph 6, wherein the nonwoven sheet comprises polyester fibers and a hydrophilic coating disposed on the polyester fibers.
8. The liquid detection laminate of paragraph 1, wherein the electrically insulating substrate is a heat sealable polyethylene terephthalate film.
9. The liquid detection laminate of paragraph 1, wherein the electrically insulating substrate is an adhesive coated polyethylene terephthalate film.
10. The liquid detection laminate of any one of paragraphs 1 to 8, wherein the liquid detection laminate is substantially free of an adhesive.
11. The liquid detection laminate of any one of paragraphs 1 to 10, wherein the liquid detection laminate consists of the electrically insulating substrate, the hydrophilic layer, and the conductive wire.
12. The liquid detection laminate of any one of paragraphs 1 to 10, further comprising a second conductive wire interposed between the electrically insulating substrate and the hydrophilic layer, wherein the second conductive wire is disposed proximal to the conductive wire.
13. The liquid detection laminate of paragraph 12, wherein the liquid detection laminate consists of the electrically insulating substrate, the hydrophilic layer, the conductive wire, and the second conductive wire.
14. An electrical cable, comprising: a cable core; an outer sheath disposed radially outward of the cable core; and the liquid detection laminate of any one of the foregoing claims interposed between the cable core and the outer sheath, wherein the hydrophilic layer is disposed adjacent the outer sheath.
15. The electrical cable of paragraph 14, wherein the liquid detection laminate is helically wrapped in the electrical cable.
16. The electrical cable of paragraph 14, wherein the liquid detection laminate is disposed longitudinally along a length of the electrical cable.
17. A method for fabricating an electrical cable, the method comprising interposing the liquid detection laminate of any one of paragraphs 1 to 13 between a cable core and an outer sheath of the electrical cable.
18. A method for detecting the ingress of water into an electrical cable, the method comprising interposing the liquid detection laminate of any one of paragraphs 1 to 13 between a cable core and a metal sheath of the electrical cable.
19. The method of paragraph 18, further comprising electrically coupling the conductive wire of the liquid detection laminate with the metal sheath of the electrical cable via a circuit.
20. The method of paragraph 18, further comprising measuring a change in one or more electrical properties via the circuit.
21. The method of paragraph 20, wherein measuring a change in one or more electrical properties via the circuit comprises measuring a change in capacity, resistivity, impedance, or a combination thereof.
22. A method for detecting the ingress of water into an electrical cable, the method comprising: disposing the liquid detection laminate of any one of paragraphs 12 and 13 radially outward of a cable core of the electrical cable; and electrically coupling the conductive wire and the second conductive wire with one another via a circuit.
23. The method of paragraph 22, further comprising measuring a change in one or more electrical properties via the circuit.
24. The method of paragraph 23, wherein measuring a change in one or more electrical properties via the circuit comprises measuring a change in capacity, resistivity, impedance, or a combination thereof.

While the devices, systems, and methods have been described in detail herein in accordance with certain preferred implementations thereof, many modifications and changes therein may be effected by those skilled in the art. Accordingly, the foregoing description should not be construed to be limited thereby but should be construed to include such aforementioned obvious variations and be limited only by the spirit and scope of the following claims.

What is claimed is:

1. A liquid detection laminate, comprising:
an electrically insulating substrate;
a hydrophilic layer disposed adjacent the electrically insulating substrate and forming a laminate therewith; and
a conductive wire interposed between the electrically insulating substrate and the hydrophilic layer.

2. The liquid detection laminate of claim 1, wherein the electrically insulating substrate comprises a polyester.

3. The liquid detection laminate of claim 2, wherein the polyester is selected from the group consisting of polyethylene terephthalate, polyethylene naphthalate, polybutylene terephthalate, poly(propylene terephthalate), and a combination thereof.

4. The liquid detection laminate of claim 3, wherein the polyester is polyethylene terephthalate.

5. The liquid detection laminate of claim 1, wherein the hydrophilic layer is a porous, nonwoven sheet configured to absorb liquids.

6. The liquid detection laminate of claim 5, wherein the nonwoven sheet comprises hydrophilic polyester fibers.

7. The liquid detection laminate of claim 6, wherein the nonwoven sheet comprises polyester fibers and a hydrophilic coating disposed on the polyester fibers.

8. The liquid detection laminate of claim 1, wherein the electrically insulating substrate is a heat sealable polyethylene terephthalate film.

9. The liquid detection laminate of claim 1, wherein the electrically insulating substrate is an adhesive coated polyethylene terephthalate film.

10. The liquid detection laminate of claim 1, wherein the liquid detection laminate is substantially free of an adhesive.

11. The liquid detection laminate of claim 1, wherein the liquid detection laminate consists of the electrically insulating substrate, the hydrophilic layer, and the conductive wire.

12. The liquid detection laminate of claim 1, further comprising a second conductive wire interposed between the electrically insulating substrate and the hydrophilic layer, wherein the second conductive wire is disposed proximal to the conductive wire.

13. The liquid detection laminate of claim 12, wherein the liquid detection laminate consists of the electrically insulating substrate, the hydrophilic layer, the conductive wire, and the second conductive wire.

14. An electrical cable, comprising:
a cable core;
an outer sheath disposed radially outward of the cable core; and
the liquid detection laminate of claim 1 interposed between the cable core and the outer sheath, wherein the hydrophilic layer is disposed adjacent the outer sheath.

15. The electrical cable of claim 14, wherein the liquid detection laminate is helically wrapped in the electrical cable.

16. The electrical cable of claim 14, wherein the liquid detection laminate is disposed longitudinally along a length of the electrical cable.

17. A method for fabricating an electrical cable, the method comprising interposing the liquid detection laminate of claim 1 between a cable core and an outer sheath of the electrical cable.

18. A method for detecting the ingress of water into an electrical cable, the method comprising interposing the liquid detection laminate of claim 1 between a cable core and a metal sheath of the electrical cable.

19. The method of claim 18, further comprising electrically coupling the conductive wire of the liquid detection laminate with the metal sheath of the electrical cable via a circuit.

20. The method of claim 18, further comprising measuring a change in one or more electrical properties via the circuit.

21. The method of claim 20, wherein measuring a change in one or more electrical properties via the circuit comprises measuring a change in capacity, resistivity, impedance, or a combination thereof.

22. A method for detecting the ingress of water into an electrical cable, the method comprising:
disposing the liquid detection laminate of claim 1 radially outward of a cable core of the electrical cable; and
electrically coupling the conductive wire and the second conductive wire with one another via a circuit.

23. The method of claim 22, further comprising measuring a change in one or more electrical properties via the circuit.

24. The method of claim 23, wherein measuring a change in one or more electrical properties via the circuit comprises measuring a change in capacity, resistivity, impedance, or a combination thereof.
